(19) United States
(12) Patent Application Publication
(10) Pub. No.: US 2014/0127413 A1
(43) Pub. Date: May 8, 2014

(54) SPRAYING SYSTEMS AND METHODS FOR THE APPLICATION OF COATING FLUIDS ONTO CELLULOSIC MIXTURES

(71) Applicant: MICHELMAN, INC., Cincinnati, OH (US)

(72) Inventors: Walter J. McGuire, Hamilton, OH (US); Chad M. Forsthoefel, Lebanon, OH (US); Phil Kreimer, Cincinnati, OH (US); James A. Hetzer, Cincinnati, OH (US)

(21) Appl. No.: 13/667,376

(22) Filed: Nov. 2, 2012

(51) Int. Cl. B27K 5/00

(52) U.S. Cl. CPC B27K 5/00
USPC 427/402; 118/314

(57) ABSTRACT

A spraying system may be used for applying a coating fluid onto a cellulosic mixture. The spraying system may include a conveyor and spraying apparatus. The conveyor may include a cellulosic mixture contacting surface and may be moveable in a conveying direction. The spraying apparatus may be operable to deliver coating fluid towards the cellulosic mixture contacting surface. The spraying apparatus may include at least one primary spray nozzle and at least one secondary spray nozzle. Each of the at least one primary spray nozzles may be oriented such that it can deliver the coating fluid in a first spray generally opposite the conveying direction. Each of the at least one secondary spray nozzles may be oriented such that it can deliver the coating fluid in a second spray generally concurrent with the conveying direction.

### BACKGROUND

1. Field

The present invention relates to the manufacture of cellulosic composites, and particularly to equipment and methods used for applying coating fluids in the manufacture of cellulosic composites.

2. Technical Background

Cellulosic composite materials are widely used as construction materials. Examples of cellulosic composite materials include materials sometimes known as “waferboard” or “chipboard”, and may be a substitute for common plywood. Cellulosic composite materials may be manufactured by compressing a cellulosic mixture, which may include a cellulosic fiber, such as “chips” or small broken-up pieces of wood material, and a binder. The cellulosic composite materials may be shaped into flat sheets suitable for use in construction, or may also be compressed into other shapes also useful in construction as well as other applications.

In the manufacture of cellulosic composite materials, the cellulosic mixture may be shaped under various temperature and pressure conditions by contact with a press. To aid in the release of the cellulosic composite material from the press, a coating fluid may be applied between the cellulosic mixture and the press prior to the pressure and/or heat treatment from the press. However, due to the composition and/or geometry of the cellulosic mixture, the entire surface of the cellulosic mixture that is contacted by the press is not coated by some coating fluid application techniques, and sticking between the cellulosic composite material and the press may result.

Accordingly, improvements in systems for applying coating fluids and methods for applying coating fluids may aid in the manufacture of cellulosic composite materials.

### SUMMARY

The embodiments described herein relate to equipment and methods used for applying coating fluids in the manufacture of cellulosic composites.

According to one embodiment, a spraying system may be used for applying a coating fluid onto a cellulosic mixture. The spraying system may comprise a conveyor and spraying apparatus. The conveyor may comprise a cellulosic mixture contacting surface and may be moveable in a conveying direction. The spraying apparatus may be operable to deliver coating fluid towards the cellulosic mixture contacting surface. The spraying apparatus may comprise at least one primary spray nozzle and at least one secondary spray nozzle. The cellulosic mixture contacting surface may be substantially flat. Each of the at least one primary spray nozzles may be oriented such that it can deliver the coating fluid in a first spray at an angle of between about 15° and about 80° relative to a line that is normal to the cellulosic mixture contacting surface. Each of the at least one primary spray nozzles may be oriented such that it can deliver the coating fluid in the first spray in a direction generally opposite the conveying direction. Each of the at least one secondary spray nozzles may be oriented such that it can deliver the coating fluid in a second spray at an angle of between about 15° and about 80° relative to a line that is normal to the cellulosic mixture contacting surface. Each of the at least one secondary spray nozzles may be oriented such that it can deliver the coating fluid in the first spray in a direction generally concurrent with the conveying direction. Each of the at least one primary spray nozzles may be positioned upstream of each of the at least one secondary spray nozzles.

In another embodiment, at least one release agent may be applied onto a cellulosic mixture during production of cellulosic composite materials. The method for applying the release agent may comprise the steps of supplying a cellulosic mixture comprising a cellulosic fiber and a binder, applying a first release agent onto the top surface of the cellulosic mixture with a first spray, and applying a second release agent onto the top surface of the cellulosic mixture with a second spray. The cellulosic mixture may have a top surface that will contact a press. The first spray may agitate the top surface of the cellulosic mixture by causing at least some cellulosic fiber material on the top surface of the cellulosic mixture to be displaced. The second spray may substantially coat the entire top surface of the cellulosic mixture. The first release agent and second release agent may comprise the same chemical composition or different chemical compositions.

In yet another embodiment, a release agent may be applied to a cellulosic mixture during production of a cellulosic composite. The method for applying the release agent may comprise the steps of supplying a spraying system, supplying a cellulosic mixture comprising a cellulosic fiber and a binder, conveying the cellulosic mixture in the conveying direction, applying the first release agent onto the top surface of the cellulosic mixture with a first spray, and applying the second release agent onto the top surface of the cellulosic mixture with a second spray. The spraying system may comprise a conveyor and a spraying apparatus. The conveyor may comprise a cellulosic mixture contacting surface and may be moveable in a conveying direction. The cellulosic mixture contacting surface may be substantially flat. The spraying apparatus may be operable to deliver a first release agent and a second release agent towards the cellulosic mixture contacting surface. The spraying apparatus may comprise at least one primary spray nozzle and at least one secondary spray nozzle. The first release agent and second release agent may comprise the same chemical composition or different chemical compositions. The cellulosic mixture may have a top surface that will contact a press. The cellulosic mixture may be positioned on the cellulosic mixture contacting surface of the conveyor. The first spray may agitate the top surface of the cellulosic mixture by causing at least some cellulosic fiber on the top surface of the cellulosic mixture to be displaced. The first spray may be oriented at an angle of between about 15° and about 80° relative to a line that is normal to the cellulosic mixture contacting surface and the first spray may be in a direction generally opposite the conveying direction. The second spray may substantially coat the entire top surface of the cellulosic mixture. The second spray may be oriented at an angle of between about 15° and about 80° relative to a line that is normal to the cellulosic mixture contacting surface and the second spray may be in a direction generally concurrent with the conveying direction.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1A depicts a schematic cut away side view of a spraying system, according to one or more embodiments described herein;

FIG. 1B depicts a schematic front view of a spray bar of the spraying system of FIG. 1A, according to one or more embodiments described herein;

FIG. 2A depicts a schematic cut away side view of a spraying system, according to one or more embodiments described herein;

FIG. 2B depicts a schematic front view of a spray bar of the spraying system of FIG. 2A, according to one or more embodiments described herein; and

FIG. 2C depicts a schematic front view of a spray bar of the spraying system of FIG. 2A, according to one or more embodiments described herein.

### DETAILED DESCRIPTION

Reference will now be made in greater detail to various embodiments of the invention, some embodiments of which are illustrated in the accompanying drawings. Whenever possible, the same reference numerals will be used throughout the drawings to refer to the same or similar parts. As is noted above, the present disclosure relates to spraying systems and methods for applying coating fluid onto cellulosic mixtures during production of cellulosic composite materials. The concepts of the present disclosure should not be limited to particular spraying system configurations. Although the present disclosure is not limited to particular types of spraying systems or the context in which the spraying systems have been used, for the purposes of illustration, some embodiments of the spraying system are illustrated and described herein with reference to use in applying a liquid release agent to a cellulosic mixture during production of cellulosic composite materials. However, other suitable structures and uses for the spraying system are contemplated herein.

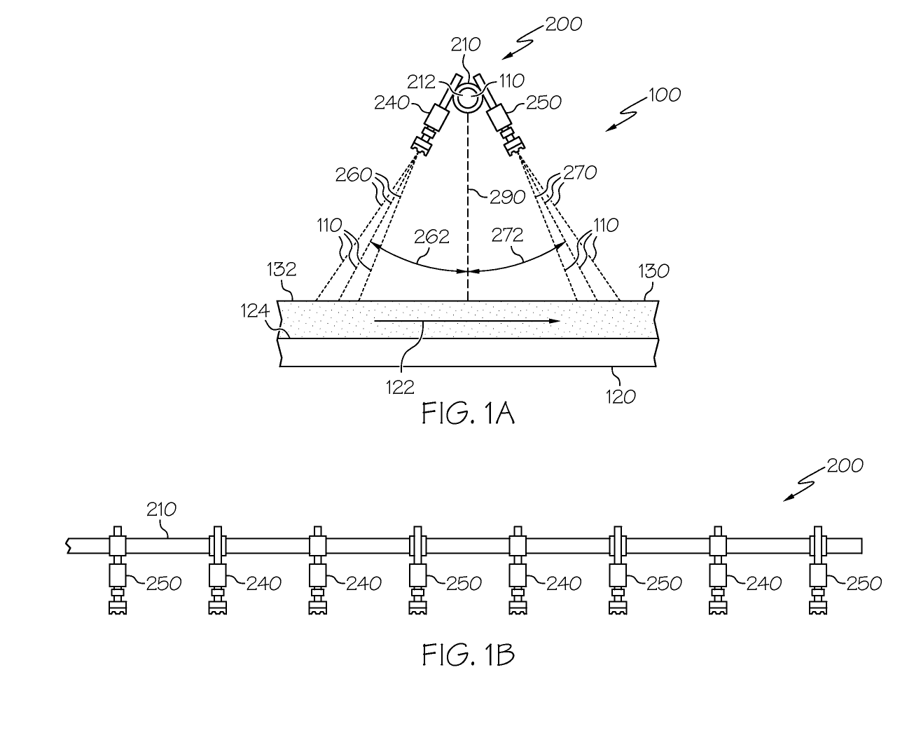

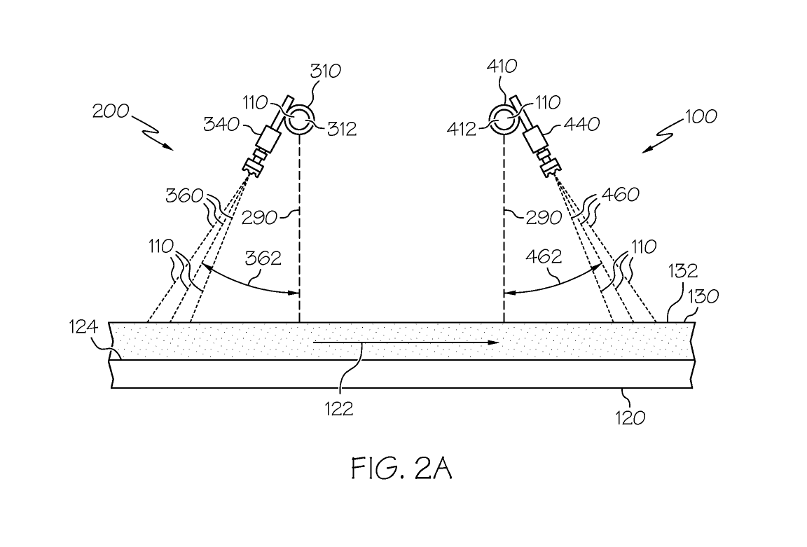

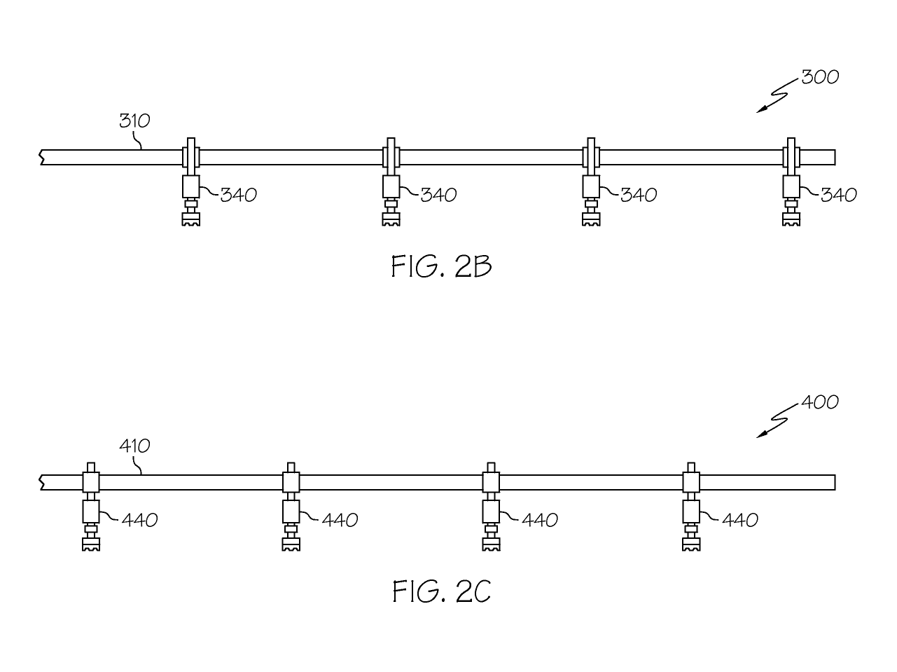

Although the particular features of the spraying system illustrated herein may vary, particular configurations according to the present disclosure are illustrated herein with reference to FIGS. 1A, 1B, 2A, 2B, and 2C. Referring to FIG. 1A, spraying systems 100 and methods described herein may generally be used for applying a coating fluid 110 onto a cellulosic mixture 130 prior to the cellulosic mixture's 130 contact with a press during the production of cellulosic composite materials. The coating fluid 110 may be applied in a plurality of sprays, such as a first spray 260, which may agitate the top surface 132 of the cellulosic mixture 130, and a second spray 270, which may substantially coat the top surface 132 of the cellulosic mixture 130 with the coating fluid 110 as the cellulosic mixture 130 is moved on a conveyor 120.

In some embodiments, the coating fluid 110 may be a release agent configured to aid in the release of the cellulosic composite from a press. The release agent may be any suitable release agent, such as silicone oil, lecithin, wax, polytetrafluoroethylene, metal salts of long chain aliphatic or cycloaliphatic acids, carboxy-functional siloxanes and vegetable oil soap surface active agents. Other release agents will be apparent to one skilled in the art.

The cellulosic mixture 130 may be comprises a cellulosic fiber and a binder. Any suitable cellulosic fiber and binder may be employed. In general, cellulosic fiber may be wood chips, wood shavings, wood wool, cork, bark, sawdust and the like waste products from the woodworking industry, and/or fibers from other natural products which are lignocellulosic, for example, bagasse, bamboo, straw, flax residues, and dried rushes, reeds and grasses. Nut shells, for example ground nuts, and hulls from cereal crops, for example rice and oats, are also contemplated as possible cellulosic fibers. Additives such as flakes and fibrous material (e.g., glass fiber, mica and asbestos) and synthetic products (e.g., rubbers and plastics) may also be included. Other cellulosic fibers and additives will be apparent to one skilled in the art.

The binder may be any suitable binder, such as formaldehyde resins (usually urea-formaldehyde, melamine-formaldehyde or phenol-formaldehyde) or an isocyanate-based binding agent. The isocyanate-based binder is generally preferred in the field and may be any suitable organic polyisocyanate either alone or in a mixture with another type of binder, for example, synthetic resin glue. The binder may be liquid, such as a solution of the binder in an inert solvent or an aqueous emulsion. Other binders will be apparent to one skilled in the art.

For example, trees may be mechanically broken-up into small chips. The chips may then be mixed with a binder, such as diphenyl methyl diisocyanurate (MDI). A specific volume of chips mixed with MDI is placed on a press where heated, top and bottom presses compress the mass into cellulosic composite material of various dimensions. A press, as described herein, may refer to any mechanical apparatus capable of applying pressure and/or heat to the cellulosic mixture to form the cellulosic composite material. Examples of suitable presses include, but are not limited to, platens and belts.

Referring generally to FIG. 1A, an improved method for applying a coating fluid 110, such as release agent, onto a cellulosic mixture 130 during production of a cellulosic composite material may comprise, generally, supplying a cellulosic mixture 130, applying to the top surface 132 of the cellulosic mixture 130 a coating fluid 110 in a first spray 260 which agitates the top surface 132 of the cellulosic mixture 130, and applying to the top surface 132 of the cellulosic mixture 130 in a second spray 270 a coating fluid 110 which substantially coats the entire top surface 132 of the cellulosic mixture 130. The first spray 260 may agitate the top surface 132 of the cellulosic mixture 130 by causing at least some cellulosic fiber material on the top surface 132 of the cellulosic mixture 130 to be displaced. The first spray 260 may be in a direction and with sufficient force to alter the geometry of the top surface 132 of the cellulosic mixture 130 by forcing some material on the top surface 132 to move or be otherwise displaced. The same area of the cellulosic mixture 130 that was contacted by the first spray 260 is then contacted by the second spray 270, which substantially coats the entire top surface 132 of the cellulosic mixture 130. As used herein, the substantial coating of the entire top surface 132 by the second spray 270 means that the second spray 270 contributes along with the first spray 260 to completely coat the top surface 132. For example, the first spray 260 may coat a substantial amount of the top surface 132, but leave some surface uncoated, including sections of the top surface 132 which were displaced by the first spray 260. The second spray 270 coats the remaining uncoated top surface 132. Without being bound by theory, it is believed that a first spray 260 which agitates the top surface 132 of the cellulosic mixture 130 and a second spray 270 that coats the top surface 132 of the cellulosic mixture 130 can have improved coverage of coating fluid 110 onto the cellulosic mixture 130 because the first spray 260 agitates the top surface 132 and allows a second spray 270 to reach areas of the top surface 132 unavailable to the first spray 260. If a conveyor 120 is employed, the spraying system 100 may be arranged so that the first spray 260 is upstream of the second spray 270 relative to the conveying direction 122. In one embodiment, the first spray 260 may be in a direction opposite the conveying direction 122 and the second spray 270 may be in a generally concurrent direction relative to the conveying direction 122. It should be understood that the first spray 260 and the second spray 270 may comprise coating fluids 110 that have the same chemical composition or have different chemical compositions. If the first spray 260 and the second spray 270 have the same chemical composition, the coating fluids 110 of the first spray 260 and the second spray 270 may come from the same coating fluid source, such as a storage vessel of any kind. The first spray 260 and/or the second spray 270 may be continuous sprays, or alternatively may be pulsing sprays. It is further contemplated that there may be one or more sprays disposed between the first spray 260 and the second spray 270 that may serve to further agitate the cellulosic mixture 130 or substantially coat the entire top surface 132 of the cellulosic mixture 130.

Specific spraying systems 100 which may be employed for applying a coating fluid 110 onto a cellulosic mixture 130 are described in detail herein. It should be understood that the embodiments of the method described above may be carried out using any of the embodiments of spraying systems 100 described herein. The spraying system 100 may generally comprise a conveyor 120 onto which the cellulosic mixture 130 may be positioned and a spraying apparatus 200 that may be operable to deliver a coating fluid 110 onto the cellulosic mixture 130. The coating fluid 110 may be delivered in a first spray 260 and a second spray 270, where the first spray 260 is oriented generally opposite the conveying direction 122 and the second spray 270 is oriented generally concurrent with the conveying direction 122. The first spray 260 that is generally opposite the conveying direction 122 may serve to agitate the top surface 132 of the cellulosic mixture 130 and the second spray 270 may serve to coat substantially the entire top surface 132 of the cellulosic mixture 130.

Referring now to FIGS. 1A and 2A, the spraying system 100 may comprise a conveyor 120 which moves a layer of cellulosic mixture 130 in a conveying direction 122. The conveyor 120 may be any suitable mechanical conveying device capable of moving a layer of a cellulosic mixture 130 in a conveying direction 122. The conveying direction 122, sometimes known as a machining direction, is shown in FIGS. 1A and 2A by an arrow showing the lateral motion of both the conveyor 120 and the layer of cellulosic mixture 130 on top of the conveyor 120. The conveyor 120 comprises a cellulosic mixture contacting surface 124 which is in contact with the cellulosic mixture 130. The cellulosic mixture contacting surface 124 may be substantially flat, such that a line 290 normal to the cellulosic mixture contacting surface 132 may exist.

Referring now to FIG. 1A, generally, the spraying system 100 may comprise a spraying apparatus 200 that is operable to deliver coating fluid 110 towards the cellulosic mixture contacting surface 124. The spraying apparatus 200 may comprise at least one primary spray nozzle 240 and at least one secondary spray nozzle 250. Each of the at least one primary spray nozzles 240 may be oriented such that it can deliver the coating fluid 110 in a first spray 260 at an angle 262 of between about 15° and about 80° relative to a line 290 that is normal to the cellulosic mixture contacting surface 124 (e.g. about 15°, about 24°, about 35°, about 45°, about 55°, about 65°, about 75°, or about 80°, or in a range between any two disclosed angles 262). Each of the at least one primary spray nozzles 240 may be oriented such that it can deliver the coating fluid 110 in the first spray 260 in a direction generally opposite the conveying direction 122. Each of the at least one secondary spray nozzles 250 may be oriented such that it can deliver the coating fluid 110 in a second spray 270 at an angle 272 of between about 15° and about 80° relative to a line 290 that is normal to the cellulosic mixture contacting surface 124 (e.g. about 15°, about 24°, about 35°, about 45°, about 55°, about 65°, about 75°, or about 80°, or in a range between any two disclosed angles 272). Each of the at least one secondary spray nozzles 250 may be oriented such that it can deliver the coating fluid 110 in the second spray 270 in a direction generally concurrent with the conveying direction 122. The terms “generally opposite” and “generally concurrent”, as used herein, refer to the direction component of a spray parallel to the cellulosic mixture contacting surface 124, such that the spray is not sprayed in exactly the opposite or concurrent direction relative to the conveying direction 122, but rather the component of the spray parallel to the cellulosic mixture contacting surface 124 (the vertical direction in FIG. 1A) is opposite or concurrent relative to the conveying direction 122. As described herein, the angles 262,272 are measured between the line 290 and about the center of the first spray 260 or second spray 270, respectively, as depicted in FIG. 1A. In one embodiment, each of the at least one primary spray nozzles 240 may be positioned upstream of each of the at least one secondary spray nozzles 250. Various exemplary embodiments of the spraying apparatus 200 will be described in detail below.

Referring now to FIGS. 1A and 1B, in one embodiment, the spraying system 100 may comprise a spraying apparatus 200 in a single spray bar configuration. The spraying apparatus 200 may comprise at least one primary spray nozzle 240 and at least one secondary spray nozzle 250, each of which may be in fluid communication with a spray bar 210. The spray bar 210 is in fluid communication with a coating fluid source, such as a fluid inlet valve that brings in a fluid from outside of the spraying system 100. The fluid communication may be provided through a pipe, tubing, or other like means that can transport a fluid.

In one embodiment, the spray bar 210 comprises a fluid flow channel 212 that may be a generally linear conduit in the spray bar 210 that allows the flow of a coating fluid 110 through the interior of the spray bar 210. The primary spray nozzles 240 and secondary spray nozzles 250 are in fluid communication with the spray bar 210 and can expel coating fluid 110. In one embodiment, the primary spray nozzles 240 and secondary spray nozzles 250 are positioned down the length of the spray bar 210, and are evenly spaced from one another. The spray nozzles 240,250 may be made of plastic or other like materials and may be capable of expelling coating fluid 110 in at least a first spray 260 and a second spray 270. The first spray 260 and second spray 270 may be in various shapes and patterns at various applied pressures of the coating fluid 110.

In another embodiment, each spray nozzle may have a separate coating fluid source. For example, each spray nozzle may be separately connected to its own coating fluid source pipe, such that multiple pipes that may deliver the coating fluid are connected to the spray bar where there is a separate pipe leading to each spray nozzle.

It should be understood that a spray, as used herein, may be created by a plurality of spray nozzles, such that multiple spray nozzles combine to produce a single spray, such as the first spray 260 or second spray 270.

In the embodiment of FIGS. 1A and 1B, each of the at least one primary spray nozzles 240 may be oriented such that it can deliver the coating fluid 110 in a first spray 260 at an angle 262 of between about 15° and about 80° relative to a line 290 that is normal to the cellulosic mixture contacting surface 124 (e.g. about 15°, about 24°, about 35°, about 45°, about 55°, about 65°, about 75°, or about 80°, or in a range between any two disclosed angles 262). Each of the at least one primary spray nozzles 240 are also oriented such that it can deliver the coating fluid 110 in the first spray 260 in a direction generally opposite the conveying direction 122. Each of the at least one secondary spray nozzles 250 may be oriented such that it can deliver the coating fluid 110 in a second spray 270 at an angle 272 of between about 15° and about 80° relative to a line 290 that is normal to the cellulosic mixture contacting surface 124 (e.g. about 15°, about 24°, about 35°, about 45°, about 55°, about 65°, about 75°, or about 80°, or in a range between any two disclosed angles 272). Each of the at least one secondary spray nozzles 250 may be oriented such that it can deliver the coating fluid 110 in the second spray 70 in a direction generally concurrent with the conveying direction 122. Each of the at least one primary spray nozzles 240 may be positioned upstream of each of the at least one secondary spray nozzles 250. In some embodiments, there are more than one primary spray nozzles 240 and/or there are more than one secondary spray nozzles 250. The primary spray nozzles 240 may be positioned in a row and/or the secondary spray nozzles 250 may be positioned in a row. In one embodiment, the first spray 260 and second spray 270 form an inverted “V” shape, emanating from the spray bar 210, as shown in FIG. 1A.

Now referring to FIGS. 2A, 2B, and 2C, in another embodiment, the spraying system 100 may comprise a spraying apparatus 200 in a two spray bar configuration. The spraying apparatus 200 may comprise at least one primary spray nozzle 340 in fluid communication with a first spray bar 310 and at least one secondary spray nozzle 450 in fluid communication with a second spray bar 410. The first spray bar 310 is in fluid communication with a coating fluid source, such as a fluid inlet valve that brings in a fluid from outside of the spraying system 100. Similarly, the second spray bar 410 is in fluid communication with a coating fluid source, such as a fluid inlet valve that brings in a fluid from outside of the spraying system 100. The fluid communication may be provided through a pipe, tubing, or other like means that can transport a fluid. The coating fluid that is dispersed from the primary spray nozzles 340 and the coating fluid 110 that is dispersed from the secondary spray nozzles 440 may come from the same coating fluid source, and may have identical compositions. Alternatively, they may have different compositions.

The first spray bar 310 and second spray bar 410 may each comprise a fluid flow channel 312,412, respectively, that may be a generally linear conduit in the spray bar 310,410 that allows the flow of a coating fluid 110 through the interior of the spray bar 310,410. The primary spray nozzles 340 are in fluid communication with the first spray bar 310 and secondary spray nozzles 440 are in fluid communication with the second spray bar 410 and can each expel coating fluid 110. In one embodiment, the primary spray nozzles 340 are positioned down the length of the first spray bar 310 and secondary spray nozzles 440 are positioned down the length of the second spray bar 410. The primary spray nozzles 340 and secondary spray nozzles 440 may be evenly spaced from one another, respectively. The spray nozzles 340,440 may be made of plastic or other like materials and may be capable of expelling coating fluid 110 in at least a first spray 360 and a second spray 460. The first spray 360 and second spray 460 may be in various shapes and patterns at various applied pressures of the coating fluid 110. The first spray bar 310 and second spray bar 410 may be spaced by any desired amount, such that the first spray 360 is delivered onto a portion of the cellulosic mixture 130 prior to the second spray 460 is delivered onto the same portion of the cellulosic mixture 130.

In the embodiment of FIGS. 2A, 2B, and 2C, each of the at least one primary spray nozzles 340 may be oriented such that it can deliver the coating fluid 110 in a first spray 360 at an angle 362 of between about 15° and about 80° relative to a line 290 that is normal to the cellulosic mixture contacting surface 124 (e.g. about 15°, about 24°, about 35°, about 45°, about 55°, about 65°, about 75°, or about 80°, or in a range between any two disclosed angles 362). Each of the at least one primary spray nozzles 340 may oriented such that it can deliver the coating fluid 110 in the first spray 360 in a direction generally opposite the conveying direction 122. Each of the at least one secondary spray nozzles 440 may be oriented such that it can deliver the coating fluid 110 in a second spray 460 at an angle 462 of between about 15° and about 80° relative to a line 290 that is normal to the cellulosic mixture contacting surface 124 (e.g. about 15°, about 24°, about 35°, about 45°, about 55°, about 65°, about 75°, or about 80°, or in a range between any two disclosed angles 462). Each of the at least one secondary spray nozzles 440 may be oriented such that it can deliver the coating fluid 110 in the second spray 460 in a direction generally concurrent with the conveying direction 122. Each of the at least one primary spray nozzles 340 may be positioned upstream of each of the at least one secondary spray nozzles 440, such that the first spray bar 310 is upstream of the second spray bar 410. In some embodiments, there are more than one primary spray nozzles 340 and/or there are more than one secondary spray nozzles 440. The primary spray nozzles 340 may be positioned in a row and/or the secondary spray nozzles 440 may be positioned in a row.

Now not referring to a specific FIG., it is generally contemplated that the spraying systems described herein may have varying first sprays and second sprays. For example, each of the at least one primary spray nozzles and/or each of the at least one secondary spray nozzles may be configured to deliver continuous sprays. In another embodiment, each of the at least one primary spray nozzles and/or each of the at least one secondary spray nozzles may be configured to deliver pulsing sprays.

In one embodiment, each of the spray nozzles may spray coating fluid having a substantially fan shape towards the top surface of the cellulosic mixture. The fan shape is defined by an apex near the spray nozzle wherein the width of the coating fluid substantially broadens in one dimension as the coating fluid is expelled away from the spray nozzle. Alternatively, the coating fluid may project out of each spray nozzle and widen in both dimensions, such as to form a substantially conical spray shape. The spray from each nozzle may alternatively widen at different rates in the two dimensions, such as to form a substantially elliptical based conical shape. In other embodiments, the spray from each nozzle may be non-symmetrical. In some embodiments, the coating fluid may be sprayed from a plurality of spray nozzles, forming a substantially flat wall of fluid.

For the purposes of describing and defining the present invention it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

It is also noted that recitations herein refer to a component of the present invention being “configured” in a particular way. In this respect, such a component is “configured” to embody a particular property, or function in a particular manner, where such recitations are structural recitations as opposed to recitations of intended use. More specifically, the references herein to the manner in which a component is “configured” denotes an existing physical condition of the component and, as such, is to be taken as a definite recitation of the structural characteristics of the component.

As used herein, the singular forms “a,” “an” and “the” include plural referents unless the context clearly dictates otherwise. Thus, for example, reference to a “nozzle” includes examples having two or more such “nozzles” unless the context clearly indicates otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Rather, the claims appended hereto should be taken as the sole representation of the breadth of the present disclosure and the corresponding scope of the various embodiments described herein. Further, it will be apparent that modifications and variations are possible without departing from the scope of the appended claims.

I claim:

1. A spraying system for applying a coating fluid onto a cellulosic mixture, the spraying system comprising:
a conveyor comprising a cellulosic mixture contacting surface, the conveyor moveable in a conveying direction; and
a spraying apparatus operable to deliver coating fluid towards the cellulosic mixture contacting surface, wherein the spraying apparatus comprises at least one primary spray nozzle and at least one secondary spray nozzle;
wherein:
the cellulosic mixture contacting surface is substantially flat;
each of the at least one primary spray nozzles is oriented such that it can deliver the coating fluid in a first spray at an angle of between about 15° and about 80° relative to a line that is normal to the cellulosic mixture contacting surface, each of the at least one primary spray nozzles also being oriented such that it can deliver the coating fluid in the first spray in a direction generally opposite the conveying direction;
each of the at least one secondary spray nozzles is oriented such that it can deliver the coating fluid in a second spray at an angle of between about 15° and about 80° relative to a line that is normal to the cellulosic mixture contacting surface, each of the at least one secondary spray nozzles also being oriented such that it can deliver the coating fluid in the first spray in a direction generally concurrent with the conveying direction; and
each of the at least one primary spray nozzles is positioned upstream of each of the at least one secondary spray nozzles.

2. The spraying system of claim 1, wherein the coating fluid is a release agent configured to aid in the release of the cellulosic composite from a press.

3. The spraying system of claim 1, further comprising a spray bar in fluid communication with a coating fluid source and configured to expel coating fluid through each of the at least one primary spray nozzles and through each of the at least one secondary spray nozzles.

4. The spraying system of claim 3, wherein there are more than one primary spray nozzles and there are more than one secondary spray nozzles.

5. The spraying system of claim 4, wherein the primary spray nozzles are positioned in a row and the secondary spray nozzles are positioned in a row.

6. The spraying system of claim 4, wherein the first spray and second spray form an inverted “V” shape.

7. The spraying system of claim 1, further comprising:
a first spray bar in fluid communication with a coating fluid source and configured to expel coating fluid through each of the at least one primary spray nozzles; and
a second spray bar in fluid communication with a coating fluid source and configured to expel coating fluid through each of the at least one secondary spray nozzles.

8. The spraying system of claim 1, wherein the each of the at least one primary spray nozzles and each of the at least one secondary spray nozzles are configured to deliver continuous sprays.

9. The spraying system of claim 1, wherein each of the at least one primary spray nozzles and each of the at least one secondary spray nozzles are configured to deliver pulsing sprays.

10. A method for applying at least one release agent onto a cellulosic mixture during production of a cellulosic composite materials, the method comprising the steps of:
supplying a cellulosic mixture comprising a cellulosic fiber and a binder, the cellulosic mixture having a top surface that will contact a press;
applying a first release agent onto the top surface of the cellulosic mixture with a first spray, the first spray agitating the top surface of the cellulosic mixture by causing at least some cellulosic fiber material on the top surface of the cellulosic mixture to be displaced;
applying a second release agent onto the top surface of the cellulosic mixture with a second spray, the second spray substantially coating the entire top surface of the cellulosic mixture, and
wherein the first release agent and second release agent comprise the same chemical composition or different chemical compositions.

11. The method claim 10, wherein the second release agent enhances release of the cellulosic mixture from a press after compression of the mixture to form a cellulosic composite.

12. The method claim 10, wherein the first spray and the second spray are applied by a spraying apparatus comprising a spray bar, the spray bar in fluid communication with a release agent source and comprising a plurality of nozzles from which the coating may be sprayed, wherein the nozzles expel the first spray and the second spray.

13. The method of claim 12, wherein the first spray and second spray form an inverted “V” shape.

14. The method claim 10, wherein the first spray is applied by a first spray bar that expels the first spray and the second spray is applied by a second spray bar that expels the second spray.

15. The method claim 10, wherein the first spray, second spray, or both, are continuous.

16. The method claim 10, wherein the first spray, second spray, or both, are pulsing.

17. A method for applying a release agent to a cellulosic mixture during production of a cellulosic composite, the method comprising the steps of:
supplying a spraying system, the spraying system comprising:
a conveyor comprising a cellulosic mixture contacting surface, the conveyor moveable in a conveying direction, wherein the cellulosic mixture contacting surface is substantially flat; and
a spraying apparatus operable to deliver a first release agent and a second release agent towards the cellulosic mixture contacting surface, wherein the spraying apparatus comprises at least one primary spray nozzle and at least one secondary spray nozzle, wherein the first release agent and second release agent comprise the same chemical composition or different chemical compositions;
supplying a cellulosic mixture comprising a cellulosic fiber and a binder, the cellulosic mixture having a top surface that will contact a press, the cellulosic mixture positioned on the cellulosic mixture contacting surface of the conveyor;
conveying the cellulosic mixture in the conveying direction;
applying the first release agent onto the top surface of the cellulosic mixture with a first spray, the first spray agitating the top surface of the cellulosic mixture by causing at least some cellulosic fiber on the top surface of the cellulosic mixture to be displaced, wherein the first spray is oriented at an angle of between about 15° and about 80° relative to a line that is normal to the cellulosic mixture contacting surface, the first spray in a direction generally opposite the conveying direction; and
applying the second release agent onto the top surface of the cellulosic mixture with a second spray, the second spray substantially coating the entire top surface of the cellulosic mixture, wherein the second spray is oriented at an angle of between about 15° and about 80° relative to a line that is normal to the cellulosic mixture contacting surface, the second spray in a direction generally concurrent with the conveying direction.

18. The method of claim 17, wherein the spraying apparatus further comprises a spray bar in fluid communication with a release agent source and configured to expel release agent through each of the at least one primary spray nozzles and each of the at least one secondary spray nozzles.

19. The method of claim 17, wherein the first spray and second spray from an inverted “V” shape.

20. The method of claim 17, wherein the spraying apparatus further comprises:
a first spray bar in fluid communication with a first release agent source and configured to expel the first release agent through each of the at least one primary spray nozzles; and
a second spray bar in fluid communication with a second release agent source and configured to expel the second release fluid through each of the at least one secondary spray nozzles.
